(19) United States
(12) Patent Application Publication
(10) Pub. No.: US 2008/0277847 A1
(43) Pub. Date: Nov. 13, 2008

(54) BUSHING HAVING SELF-LUBRICATING OVERMOLD

(75) Inventor: Robert C. Missig, Berlin Heights, OH (US)

Correspondence Address: HARNESS, DICKEY & PIERCE, P.L.C., P.O. BOX 828, BLOOMFIELD HILLS, MI, 48303, US

(73) Assignee: THE PULLMAN COMPANY, Milan, OH (US)

(21) Appl. No.: 12/117,109

(22) Filed: May 8, 2008

Related U.S. Application Data
(60) Provisional application No. 60/928,968, filed on May 11, 2007.

(51) Int. Cl. F16F 7/00; B23P 11/02

(52) U.S. Cl. 267/141.3; 29/451

(57) ABSTRACT

An elastomeric bushing has an outer structural member within which is located an outer elastomeric member, a self-lubricating elastomer and an inner structural member. The self-lubricating elastomer is located between the inner structural member and the outer structural member and is overmolded with the outer elastomeric member to provide adhesion between the self-lubricating elastomer and the outer elastomeric member. The self-lubricating elastomer can be located between the outer structural member and the outer elastomeric member or between the inner structural member and the outer elastomeric member.

### CROSS-REFERENCE TO RELATED APPLICATIONS

This application claims the benefit of U.S. Provisional Application No. 60/928,968, filed on May 11, 2007. The disclosure of the above application is incorporated herein by reference.

### FIELD

The present disclosure relates to a rubber-metal bushing for a suspension system. More particularly, the present disclosure relates to a rubber-metal bushing for a suspension system which incorporates an overmolded self-lubricating elastomer.

### BACKGROUND

The statements in this section merely provide background information related to the present disclosure and may not constitute prior art.

A typical rubber-metal bushing used in an automobile suspension system to reduce or control vibration, ride, handling and noise comprises a central, inner metal or plastic tube, an outer metal or plastic tube and an elastomeric member disposed between the inner and outer tubes. Each of the inner tube, the outer tube and the elastomeric member has a generally cylindrical geometry. The elastomeric member may be natural rubber or a different elastomeric member having a specific durometer.

In use, the outer member is press fit into one of an adjacent structural member or an adjacent suspension member and a bolt or other retainer is assembled through the inner tube and through the other of the adjacent structural member or the adjacent suspension member of the automobile. A nut or other retainer is assembled to the free end of the bolt and the bushing is secured by the tightening of the nut onto the bolt. The open ends of the elastomeric member may bear against the structural or the suspension members or the head of the nut and/or bolt to encapsulate the elastomeric member. In other designs, a separate component is added to the ends of the bushing to encapsulate the elastomeric member.

These bushings are torsional spring type devices with limited oscillatory capability and a parasitic torsional spring rate. The elastomeric member is secured to the inner tube and the outer tube by high compression or it is chemically bonded to one or both of the tubes. The elastomeric member is used to perform several functions simultaneously such as providing vibration damping or isolation and providing rotary motion between the inner and outer tubes. These differing requirements pose conflicting material development and design issues. As a result, there is a need for a cost effective, low torsional rate tunable bushing.

Prior art designs for low torsional rate bushings include Teflon cloth lined elastomeric members, silicone grease lubricated elastomeric members, a separate Teflon molded-component, and a separate self-lubricating elastomer molded component.

The Teflon cloth, silicone grease and the separate Teflon molded component utilized with the elastomeric member have a limited finite life and they will typically wear out under cyclical loading and rotation. The self-lubricating elastomer has lubrication on all surfaces and it cannot carry static and dynamic loading without displacing away from the loading due to its low coefficient of friction on all of its surfaces.

### SUMMARY

The present disclosure provides an elastomeric bushing where either the self-lubricated elastomer or the elastomeric member is molded first. Then, the other of the self-lubricated elastomer or the elastomeric member is overmolded to the other component. The overmold portion is produced in such a fashion that excellent adhesion occurs between the two dissimilar materials without the inclusion of any adhesive or tackifier agents. This adhesion is then capable of being subjected to normal bushing static and dynamic loading without separation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an end view of a bushing assembly in accordance with the present disclosure;

FIG. 2 is a cross-sectional view of the bushing assembly illustrated in FIG. 1;

FIG. 3 is a cross-sectional view of a separate self-lubricating elastomeric member;

FIG. 4 is a cross-sectional view of a separate outer elastomeric member;

FIG. 5 is a cross-sectional view of an overmolded component including the self-lubricating elastomeric member and the outer elastomeric member;

FIG. 6 is a cross-sectional view of a bushing assembly in accordance with another embodiment of the present invention;

FIG. 7 is a cross-sectional view of an overmolded component illustrated in FIG. 6 including the self-lubricating elastomeric member and the outer elastomeric member;

FIG. 8 is a side view of a bushing assembly in accordance with another embodiment of the present invention; and

FIG. 9 is a cross-sectional view of an overmolded component illustrated in FIG. 8 including the self-lubricating elastomeric member and the outer elastomeric member.

### DETAILED DESCRIPTION

The following description is merely exemplary in nature and is not intended to limit the present disclosure, application, or uses.

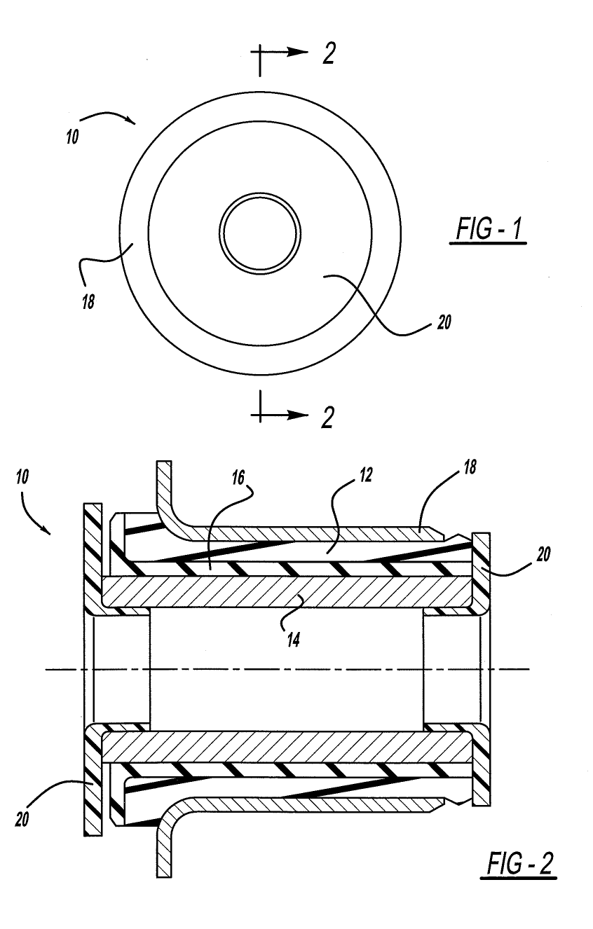

Referring now to FIGS. 1-5, an elastomeric bushing assembly in accordance with the present disclosure is illustrated and is designated generally by the reference numeral 10. Elastomeric bushing assembly 10 comprises an outer elastomeric member 12, an inner structural member 14, a self-lubricating elastomer 16, an outer structural member 18 and a pair of ferrules 20.

Self-lubricating elastomer 16 is disposed between outer elastomeric member 12 and inner structural member 14. The assembly of outer elastomeric member 12, self-lubricating elastomer 16 and inner structural member 14 is disposed within outer structural member 18. The outside diameter of outer elastomeric member 12 prior to being inserted into outer structural member 18 is larger than the inside diameter of outer structural member 18 to provide a specified percent compression of outer elastomeric member 12. The compression of outer elastomeric member 12 creates a mechanical bond between outer elastomeric member 12 and outer structural member 18 which resists the rotation of outer elastomeric member 12 with respect to outer structural member 18.

In addition, the overmolding of outer elastomeric member 12 and self-lubricating elastomer 16, as described below, creates an adhesion between the two materials and this adhesion resists the rotation of self-lubricating elastomer 16 with respect to outer elastomeric member 12. Ferrules 20 are disposed within the inside diameter of inner structural member 14 as illustrated in FIG. 2. Rotation of ferrules 20 and inner structural member 14 with respect to outer structural member 18 will occur at the interface between inner structural member 14 and self-lubricating elastomer 16 due to the adhesion between self-lubricating elastomer 16 and outer elastomeric member 12 created during the overmolding process and because of the compression of outer elastomeric member 12 when it is inserted into outer structural member 18.

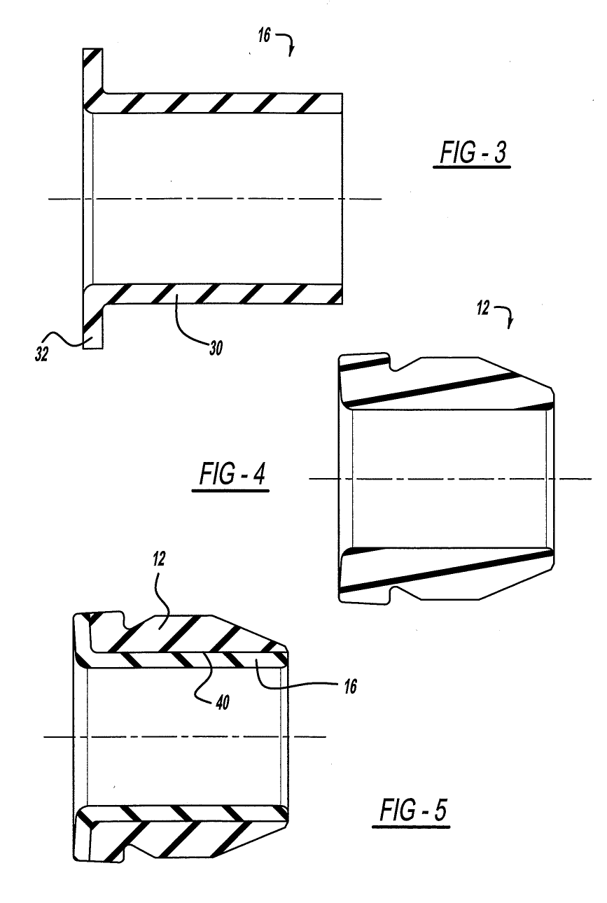

Referring now to FIGS. 3 and 5, a first method for producing elastomeric bushing assembly 10 is illustrated. As shown in FIG. 3, self-lubricating elastomer 16 is molded or formed as a generally cylindrical member having an axially extending cylindrical portion 30 and a radially outwardly extending flange 32. Once self-lubricating elastomer 16 has been formed, as illustrated in FIG. 3, it is inserted into a mold and outer elastomeric member 12 is overmolded over the outside surface of self-lubricating elastomer 16 as illustrated in FIG. 5. The overmolding of outer elastomeric member 12 to self-lubricating elastomer 16 is produced in such a fashion that an excellent adhesion bond 40 occurs between outer elastomeric member 12 and self-lubricating elastomer 16 without the inclusion of adhesive or tackifier agents. This adhesion is capable of being subjected to normal bushing static and dynamic loading without separation.

Referring now to FIGS. 4 and 5, a second method for producing elastomeric bushing assembly 10 is illustrated. As shown in FIG. 4, outer elastomeric member 12 is molded or formed as a generally cylindrical member having an exterior surface formed to provide the required isolation properties for elastomeric bushing assembly 10. Once outer elastomeric member 12 has been formed as illustrated in FIG. 4, it is inserted into a mold and self-lubricating elastomer 16 is overmolded with the inside and end surface of outer elastomeric member 12 as illustrated in FIG. 5. The overmolding of self-lubricating elastomer 16 to outer elastomeric member 12 is produced in such a fashion that adhesion bond 40 occurs between self-lubricating elastomer 16 and outer elastomeric member 12 without the inclusion of any adhesive or tackifier agents. This adhesion is capable of being subjected to normal bushing static and dynamic loading without separation.

Once self-lubricating elastomer 16 and outer elastomeric member 12 are formed by either of the two methods described above and illustrated in FIG. 5, inner structural member 14 is inserted into self-lubricating elastomer 16, ferrules 20 are assembled into inner structural member 14 and outer elastomeric member 12 is assembled into outer structural member 18 to complete the assembly of elastomeric bushing assembly 10.

Elastomeric bushing assembly 10 has high load, set, creep, tensile and friction properties and is thus able to sustain integrity and load carrying properties while self-lubricating elastomer 16 is demonstrating its low friction and low wear properties while allowing rotation of inner structural member 14 and ferrules 20 with respect to outer structural member 18.

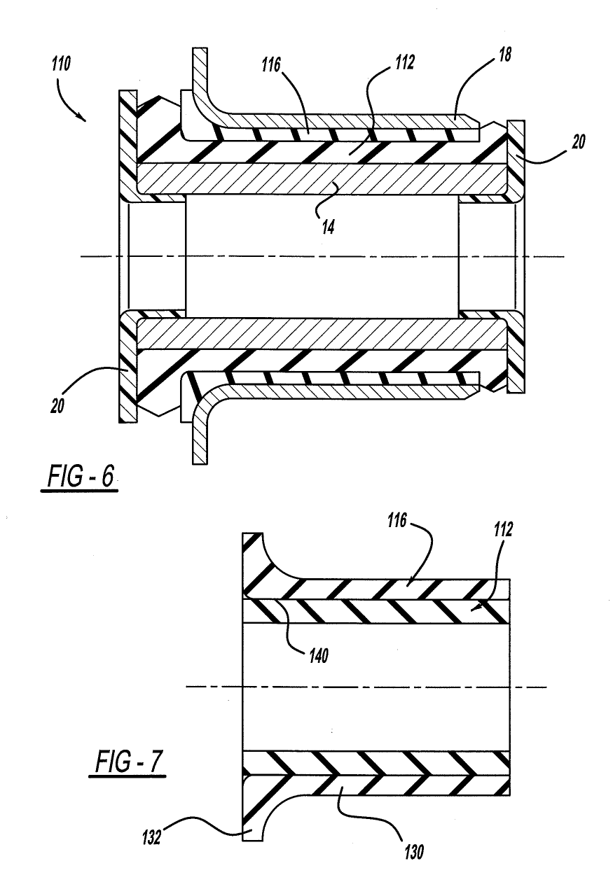

Referring now to FIGS. 6 and 7, an elastomeric bushing assembly in accordance with the present disclosure is illustrated and is designated generally by the reference numeral 110. Elastomeric bushing assembly 110 comprises an outer elastomeric member 112, inner structural member 14, a self-lubricating elastomer 116, outer structural member 18 and the pair of ferrules 20.

Self-lubricating elastomer 116 is disposed between outer elastomeric member 112 and outer structural member 18. The assembly of outer elastomeric member 112, self-lubricating elastomer 116 and outer structural member 18 is disposed over inner structural member 14. The inside diameter of outer elastomeric member 112 prior to being installed over inner structural member 14 is smaller than the outside diameter of inner structural member 14 to provide a specified percent compression of outer elastomeric member 112. The compression of outer elastomeric member 112 creates a mechanical bond between outer elastomeric member 112 and inner structural member 14 which resists the rotation of outer elastomeric member 112 with respect to inner structural member 14.

In addition, the overmolding of outer elastomeric member 112 and self-lubricating elastomer 116, as described below, creates an adhesion between the two materials and this adhesion resists the rotation of self-lubricating elastomer 116 with respect to outer elastomeric member 112. Ferrules 20 are disposed within the inside diameter of inner structural member 14 as illustrated in FIG. 6. Rotation of ferrules 20 and inner structural member 14 with respect to outer structural member 18 will occur at the interface between outer structural member 18 and self-lubricating elastomer 116 due to the adhesion between self-lubricating elastomer 116 and outer elastomeric member 112 created during the overmolding process and because of the compression of outer elastomeric member 112 when it is assembled over inner structural member 14.

Referring now to FIG. 7, a first method for producing elastomeric bushing assembly 110 is illustrated. As shown in FIG. 7, self-lubricating elastomer 116 is molded or formed as a generally cylindrical member having an axially extending cylindrical portion 130 and a radially outwardly extending flange 132. Once self-lubricating elastomer 116 has been formed, as illustrated in FIG. 7, it is inserted into a mold and outer elastomeric member 112 is overmolded over the inside surface of self-lubricating elastomer 116 as illustrated in FIG. 7. The overmolding of outer elastomeric member 112 to self-lubricating elastomer 116 is produced in such a fashion that an excellent adhesion bond 140 occurs between outer elastomeric member 112 and self-lubricating elastomer 116 without the inclusion of adhesive or tackifier agents. This adhesion is capable of being subjected to normal bushing static and dynamic loading without separation.

Referring now to FIG. 7, a second method for producing elastomeric bushing assembly 110 is illustrated. As shown in FIG. 7, outer elastomeric member 112 is molded or formed as a generally cylindrical member having an interior surface formed to provide the required isolation properties for elastomeric bushing assembly 110. Once outer elastomeric member 112 has been formed as illustrated in FIG. 7, it is inserted into a mold and self-lubricating elastomer 116 is overmolded with the outside surface of outer elastomeric member 112 as illustrated in FIG. 7. The overmolding of self-lubricating elastomer 116 to outer elastomeric member 112 is produced in such a fashion that adhesion bond 140 occurs between self-lubricating elastomer 116 and outer elastomeric member 112 without the inclusion of any adhesive or tackifier agents. This adhesion is capable of being subjected to normal bushing static and dynamic loading without separation.

Once self-lubricating elastomer 116 and outer elastomeric member 112 are formed by either of the two methods described above and illustrated in FIG. 7, outer structural member 18 is inserted over self-lubricating elastomer 116, outer elastomeric member 112 is assembled over inner structural member 14 and ferrules 20 are assembled into inner structural member 14 to complete the assembly of elastomeric bushing assembly 110.

Elastomeric bushing assembly 110 has high load, set, creep, tensile and friction properties and is thus able to sustain integrity and load carrying properties while self-lubricating elastomer 116 is demonstrating its low friction and low wear properties while allowing rotation of inner structural member 14 and ferrules 20 with respect to outer structural member 18.

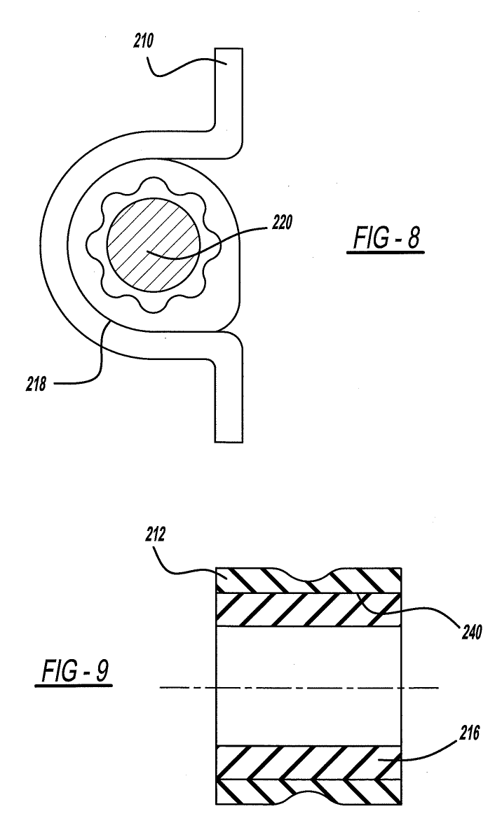

Referring now to FIGS. 7 and 8, an elastomeric bushing assembly in accordance with the present disclosure is illustrated and is designated generally by the reference numeral 210. Elastomeric bushing assembly 210 comprises an outer elastomeric member 212, a self-lubricating elastomer 216 and an outer structural member 218.

Self-lubricating elastomer 216 is disposed between outer elastomeric member 212 and a stabilizer bar 220. The assembly of outer elastomeric member 212 and self-lubricating elastomer 216 is assembled over stabilizer bar 220 and outer structural member 218 is assembled over outer elastomeric member 212. A split 222 assists in the assembly of outer elastomeric member 212 and self-lubricating elastomer 216. The outside diameter of outer elastomeric member 212 prior to being assembled with outer structural member 218 is larger than the inside diameter of outer structural member 218 to provide a specified percent compression of outer elastomeric member 212. The compression of outer elastomeric member 212 creates a mechanical bond between outer elastomeric member 212 and outer structural member 218 which resists the rotation of outer elastomeric member 212 with respect to outer structural member 218.

In addition, the overmolding of outer elastomeric member 212 and self-lubricating elastomer 216, as described below, creates an adhesion between the two materials and this adhesion resists the rotation of self-lubricating elastomer 216 with respect to outer elastomeric member 212. Rotation of stabilizer bar 220 with respect to outer structural member 218 will occur at the interface between stabilizer bar 220 and self-lubricating elastomer 216 due to the adhesion between self-lubricating elastomer 216 and outer elastomeric member 212 created during the overmolding process and because of the compression of outer elastomeric member 212 when it is assembled with outer structural member 218.

Referring now to FIG. 8, a first method for producing elastomeric bushing assembly 210 is illustrated. As shown in FIG. 8, self-lubricating elastomer 216 is molded or formed as a generally cylindrical member having an axially extending cylindrical portion. Once self-lubricating elastomer 216 has been formed, as illustrated in FIG. 8, it is inserted into a mold and outer elastomeric member 212 is overmolded over the outside surface of self-lubricating elastomer 216 as illustrated in FIG. 8. The overmolding of outer elastomeric member 212 to self-lubricating elastomer 216 is produced in such a fashion that an excellent adhesion bond 240 occurs between outer elastomeric member 212 and self-lubricating elastomer 216 without the inclusion of adhesive or tackifier agents. This adhesion is capable of being subjected to normal bushing static and dynamic loading without separation.

Referring now to FIG. 8, a second method for producing elastomeric bushing assembly 210 is illustrated. As shown in FIG. 8, outer elastomeric member 212 is molded or formed as a generally cylindrical member having an exterior surface formed to provide the required isolation properties for elastomeric bushing assembly 210. Once outer elastomeric member 212 has been formed as illustrated in FIG. 8, it is inserted into a mold and self-lubricating elastomer 216 is overmolded with the inside surface of outer elastomeric member 212 as illustrated in FIG. 8. The overmolding of self-lubricating elastomer 216 to outer elastomeric member 212 is produced in such a fashion that adhesion bond 240 occurs between self-lubricating elastomer 216 and outer elastomeric member 212 without the inclusion of any adhesive or tackifier agents. This adhesion is capable of being subjected to normal bushing static and dynamic loading without separation.

Once self-lubricating elastomer 216 and outer elastomeric member 212 are formed by either of the two methods described above and illustrated in FIG. 8, self-lubricating elastomer 216 and outer elastomeric member 212 are assembled over stabilizer bar 220 and outer structural member 218 is assembled over outer elastomeric member 212 to complete the assembly of elastomeric bushing assembly 210.

Elastomeric bushing assembly 210 has high load, set, creep, tensile and friction properties and is thus able to sustain integrity and load carrying properties while self-lubricating elastomer 216 is demonstrating its low friction and low wear properties while allowing rotation of stabilizer bar 220 with respect to outer structural member 18.

What is claimed is:

1. An elastomeric bushing comprising:
an outer structural member;
an outer elastomeric member disposed within said outer structural member;
a self-lubricating elastomer disposed between said inner and outer elastomeric member; and
an inner structural member disposed within said outer elastomeric member; wherein
said self-lubricating elastomer is overmolded with said outer elastomeric member.

2. The elastomeric bushing according to claim 1 wherein said self-lubricating elastomer is overmolded to said outer elastomeric member.

3. The elastomeric bushing according to claim 2 wherein said self lubricating elastomer is overmolded to an inside surface of said outer elastomeric member.

4. The elastomeric bushing according to claim 2 wherein said self lubricating elastomer is overmolded to an outside surface of said outer elastomeric member.

5. The elastomeric bushing according to claim 1 wherein said outer elastomeric member is overmolded to said self-lubricating elastomer.

6. The elastomeric bushing according to claim 5 wherein said outer elastomeric member is overmolded to an inside surface of said self lubricating elastomer.

7. The elastomeric bushing according to claim 5 wherein said outer elastomeric member is overmolded to an outside surface of said self lubricating elastomer.

8. The elastomeric bushing according to claim 1 further comprising an adhesion bond between said self-lubricating elastomer and said outer elastomeric member.

9. The elastomeric bushing according to claim 8 wherein an adhesive or a tackifier agent is not disposed between said self-lubricating elastomer and said outer elastomeric member.

10. A method for producing an elastomeric bushing comprising:
overmolding a self-lubricating elastomer with an outer elastomeric bushing;
assembling one of said inner structural member and said outer structural member to said self-lubrication elastomer;
assembling said outer elastomeric bushing to the other of said inner structural member and said outer structural member.

11. The method according to claim 10 wherein in said overmolding step, said self-lubricating elastomer is overmolded to said outer elastomeric member.

12. The method according to claim 11 wherein in said overmolding step, said self-lubricating elastomer is overmolded to an inside surface said outer elastomeric member.

13. The method according to claim 11 wherein in said overmolding step, said self-lubricating elastomer is overmolded to an outside surface said inner elastomeric member.

14. The method according to claim 10 wherein in said overmolding step, said outer elastomeric member is overmolded to said self lubricating elastomer.

15. The method according to claim 14 wherein in said overmolding step, said outer elastomeric member is overmolded to an inside surface of said self-lubricating elastomer.

16. The method according to claim 11 wherein in said overmolding step, said outer elastomeric member is overmolded to an outside surface said self-lubricating elastomer.

17. The method according to claim 10 further comprising providing an adhesion bond between said self-lubricating elastomer and said outer elastomeric member.

18. The method according to claim 17 wherein in said step of providing adhesion, an adhesive or a tackifier agent is not provided between said self-lubricating elastomer and said outer elastomeric member.
